(19) United States
(12) Patent Application Publication
(10) Pub. No.: US 2019/0388716 A1
(43) Pub. Date: Dec. 26, 2019

(54) Trauma Relief Strap Assembly for Safety Harness

(71) Applicant: MSA Technology, LLC, Cranberry Township, PA (US)

(72) Inventor: Ryan Barrow, Pittsburgh, PA (US)

(21) Appl. No.: 16/018,109

(22) Filed: Jun. 26, 2018

(51) Int. Cl. A62B 35/00

(52) U.S. Cl. CPC A62B 35/0031; A62B 35/0075; A62B 35/0018

(57) ABSTRACT

A trauma relief strap assembly has a relief strap with a first strap and a second strap connected to the first strap at two or more connection points along a major longitudinal length of the relief strap. The relief strap further has one or more steps formed as a closed loop between two adjacent connection points. Each step has a longitudinal portion extending in a direction of the major longitudinal length of the relief strap and defined by one of the first strap and the second strap, and a lateral portion protruding laterally from the longitudinal portion and defined by the other of the first strap and the second strap.

### BACKGROUND OF THE INVENTION

### Field of the Invention

The present invention relates generally to safety devices and arrangements, e.g., safety harnesses, and, in particular, to a safety harness having a trauma relief strap assembly.

### Description of the Related Art

As is known in the art, there exist various safety devices and arrangements that can be worn by or attached to a user to ensure the wearer's safety in certain situations. Such arrangements come in many forms, including, but not limited to, safety harnesses and safety belts. Full body safety harnesses are widely used for lifting and lowering individuals in dangerous situations and as a primary component in a personal fall arrest system. These safety harnesses can also be used for work positioning, travel restriction, ladder climbing, rescue retrieval, and evacuation. While these safety harnesses are used mainly in an industrial setting, and particularly the construction industry where the likelihood and danger of falls from heights is both numerous and significant, a full body harness can be used in various other applications in which total suspension and support of the body must be ensured, either expectedly or unexpectedly.

While there are many variations in full body safety harness construction, all typically include a plurality of elongate straps that are directly or indirectly attached together to fit around a user's body. In some embodiments or aspects, a full body safety harness may have an attachment point (e.g., a D-ring) typically positioned in a central portion of the user's back, and a plurality of straps routed around predetermined portions of the user's body. In the event of a fall, the user's body is suspended within the safety harness which is secured to a safety line by the D-ring. The user may remain suspended within the safety harness for a length of time, which may lead to a restriction of blood flow due to pressure applied to the user's legs by the leg straps of the safety harness. Further, prolonged suspension in the safety harness may result in significant discomfort, loss of consciousness, and/or injury to the user.

Accordingly, there is a need in the art for an improved safety harness that addresses certain drawbacks and deficiencies with existing safety harnesses. In particular, there is a need for an improved safety harness that reduces or eliminates the restriction of blood flow due to pressure applied to the user's legs by the leg straps of the safety harness. There is also a need for an improved safety harness with increased safety compliance at the worksite, and with more effective and safe support of the user in the event of a fall.

### SUMMARY OF THE INVENTION

Generally, provided is an improved safety harness having an integrated trauma relief strap assembly. Preferably, provided is an improved safety harness with an integrated trauma relief strap assembly that can be easily and effectively worn by the user in a variety of work environments without compromising the user's ability to move and without adding significant weight that must be borne by the user. Preferably, provided is an improved safety harness with an integrated trauma relief strap assembly that not only leads to increased safety compliance at the worksite, but also provides increased effectiveness to the personal fall protection system and a resulting increase in the safety of the user in the event of a fall.

In some non-limiting embodiments or aspects, provided is a trauma relief strap assembly that may have a relief strap with a first strap and a second strap connected to the first strap at two or more connection points along a major longitudinal length of the relief strap. The relief strap may further have one or more steps formed as a closed loop between two adjacent connection points. Each step may have a longitudinal portion extending in a direction of the major longitudinal length of the relief strap and defined by one of the first strap and the second strap, and a lateral portion protruding laterally from the longitudinal portion and defined by the other of the first strap and the second strap.

In other non-limiting embodiments or aspects, for at least one connection point, the first strap may be folded over itself in a first lateral direction away from the second strap and the second strap may be folded over itself in a second lateral direction away from the first strap. The lateral portion of each step may automatically unfold from the longitudinal portion when the relief strap is in a deployed configuration. The first strap and the second strap may be connected together at each connection point by stitching. The relief strap may have a first end, an intermediate portion, and a second end. The first strap and the second strap may be connected together along at least the intermediate portion. The one or more steps may be a plurality of steps extending from each lateral side of the relief strap. The plurality of steps may be offset along the major longitudinal length of the relief strap. One of the first strap and the second strap may be configured for non-removably connecting to a wearable body harness.

In other non-limiting embodiments or aspects, one of the first strap and the second strap may have a pull strap configured for deploying the relief strap from the stowed configuration to a deployed configuration. The pull strap may be at least partially exposed from a housing when the relief strap is in the stowed configuration. Indicia may be formed on at least a portion of the pull strap.

In other non-limiting embodiments or aspects, the trauma relief strap assembly may have a housing for receiving at least a portion of the relief strap in a stowed configuration. The housing may have a pocket with an interior cavity shaped to receive at least a portion of the relief strap. The housing may be configured as a pad. The housing may have a flap movable between a closed position to enclose the pocket and an open position to open the pocket. The flap may be secured in the closed position by at least one connector.

In other non-limiting embodiments or aspects, provided is a safety harness that may have a first leg strap and a second leg strap, and a trauma relief strap assembly connected to each of the first leg strap and the second leg strap. The trauma relief strap assembly may have a relief strap with a first strap and a second strap connected to the first strap at two or more connection points along a major longitudinal length of the relief strap. The relief strap may further have one or more steps formed as a closed loop between two adjacent connection points. Each step may have a longitudinal portion extending in a direction of the major longitudinal length of the relief strap and defined by one of the first strap and the second strap, and a lateral portion protruding laterally from the longitudinal portion and defined by the other of the first strap and the second strap.

In other non-limiting embodiments or aspects, for at least one connection point, the first strap may be folded over itself in a first lateral direction away from the second strap and the second strap may be folded over itself in a second lateral direction away from the first strap. The trauma relief strap assembly may be deployable between a stowed configuration in which the relief strap is stored within a housing, and a deployed configuration in which the relief strap extends out of the housing and substantially parallel to a user. The lateral portion of each step may automatically unfold from the longitudinal portion when the relief strap is in the deployed configuration to allow for insertion of a user's foot into each step.

In other non-limiting embodiments or aspects, provided is a trauma relief strap assembly that may have a relief strap with a first end configured for connecting to at least a portion of a wearable body harness, an intermediate portion, and a second end. The intermediate portion may have a first strap and a second strap connected to the first strap at two or more connection points along a major longitudinal length of the intermediate portion. The intermediate portion may further have one or more steps formed as a closed loop between two adjacent connection points. Each step may have a longitudinal portion extending in a direction of the major longitudinal length of the relief strap and defined by one of the first strap and the second strap, and a lateral portion protruding laterally from the longitudinal portion and defined by the other of the first strap and the second strap. At each connection point, the first strap may be folded over itself in a first lateral direction away from the second strap and the second strap may be folded over itself in a second lateral direction away from the first strap.

Further non-limiting embodiments or aspects will now be set forth in the following numbered clauses.

Clause 1: A trauma relief strap assembly, comprising: a relief strap having a first strap and a second strap connected to the first strap at two or more connection points along a major longitudinal length of the relief strap, and one or more steps formed as a closed loop between two adjacent connection points, wherein each step has a longitudinal portion extending in a direction of the major longitudinal length of the relief strap and defined by one of the first strap and the second strap, and a lateral portion protruding laterally from the longitudinal portion and defined by the other of the first strap and the second strap.

Clause 2: The trauma relief strap assembly of clause 1, wherein, for at least one connection point, the first strap is folded over itself in a first lateral direction away from the second strap and the second strap is folded over itself in a second lateral direction away from the first strap.

Clause 3: The trauma relief strap assembly of clause 1 or clause 2, wherein the lateral portion of each step automatically unfolds from the longitudinal portion when the relief strap is in a deployed configuration to allow for insertion of a user's foot into each step.

Clause 4: The trauma relief strap assembly of any of clauses 1-3, wherein the first strap and the second strap are connected together at each connection point by stitching.

Clause 5: The trauma relief strap assembly of any of clauses 1-4, wherein the relief strap has a first end, an intermediate portion, and a second end, and wherein the first strap and the second strap are connected together along at least the intermediate portion.

Clause 6: The trauma relief strap assembly of any of clauses 1-5, wherein the one or more steps is a plurality of steps extending from each lateral side of the relief strap.

Clause 7: The trauma relief strap assembly of any of clauses 1-6, wherein the plurality of steps are offset along the major longitudinal length of the relief strap.

Clause 8: The trauma relief strap assembly of any of clauses 1-7, wherein one of the first strap and the second strap is configured for non-removably connecting to a wearable body harness.

Clause 9: The trauma relief strap assembly of any of clauses 1-8, wherein one of the first strap and the second strap has a pull strap configured for deploying the relief strap from the stowed configuration to a deployed configuration.

Clause 10: The trauma relief strap assembly of any of clauses 1-9, wherein the pull strap is at least partially exposed from a housing when the relief strap is in a stowed configuration.

Clause 11: The trauma relief strap assembly of any of clauses 1-10, further comprising indicia on at least a portion of the pull strap.

Clause 12: The trauma relief strap assembly of any of clauses 1-11, further comprising a housing for receiving at least a portion of the relief strap in a stowed configuration.

Clause 13: The trauma relief strap assembly of any of clauses 1-12, wherein the housing has a pocket with an interior cavity shaped to receive at least a portion of the relief strap.

Clause 14: The trauma relief strap assembly of any of clauses 1-13, wherein the housing is configured as a pad.

Clause 15: The trauma relief strap assembly of any of clauses 1-14, wherein the housing has a flap movable between a closed position to enclose the pocket and an open position to open the pocket.

Clause 16: A safety harness, comprising: a first leg strap and a second leg strap; and a trauma relief strap assembly connected to each of the first leg strap and the second leg strap, the trauma relief strap assembly comprising: a relief strap having a first strap connected to the first leg strap or the second leg strap and a second strap connected to the first strap at two or more connection points along a major longitudinal length of the relief strap, and one or more steps formed as a closed loop between two adjacent connection points, wherein each step has a longitudinal portion extending in a direction of the major longitudinal length of the relief strap and defined by one of the first strap and the second strap, and a lateral portion protruding laterally from the longitudinal portion and defined by the other of the first strap and the second strap.

Clause 17: The safety harness of clause 16, wherein, for at least one connection point, the first strap is folded over itself in a first lateral direction away from the second strap and the second strap is folded over itself in a second lateral direction away from the first strap.

Clause 18: The safety harness of clause 16 or clause 17, wherein the trauma relief strap assembly is deployable between a stowed configuration in which the relief strap is stored within a housing, and a deployed configuration in which the relief strap extends out of the housing and substantially parallel to a user.

Clause 19: The safety harness of any of clauses 16-18, wherein the lateral portion of each step automatically unfolds from the longitudinal portion when the relief strap is in the deployed configuration to allow for insertion of a user's foot into each step.

Clause 20: A trauma relief strap assembly, comprising: a relief strap having a first end configured for connecting to at least a portion of a wearable body harness, an intermediate portion, and a second end, the intermediate portion comprising a first strap and a second strap connected to the first strap at two or more connection points along a major longitudinal length of the intermediate portion, and one or more steps formed as a closed loop between two adjacent connection points, wherein each step has a longitudinal portion extending in a direction of the major longitudinal length of the relief strap and defined by one of the first strap and the second strap, and a lateral portion protruding laterally from the longitudinal portion and defined by the other of the first strap and the second strap, and wherein, at each connection point, the first strap is folded over itself in a first lateral direction away from the second strap and the second strap is folded over itself in a second lateral direction away from the first strap.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a front view of a wearable fall protection harness in accordance with the principles of the present invention;

FIG. 2 is a side view of a housing containing a trauma relief strap in a stowed configuration in accordance with the principles of the present invention;

FIG. 3A is a front view of the trauma relief strap in a deployed configuration;

FIG. 3B is an exploded front view of the trauma relief strap shown in FIG. 3A;

FIG. 4 is a detailed view of a connection between portions of the trauma relief strap shown in FIG. 3A;

FIG. 5 is a side view of a first strap of the trauma relief strap shown in FIG. 3A;

FIG. 6 is a side view of a second strap of the trauma relief strap shown in FIG. 3A;

FIG. 7 is a front exploded view of a trauma relief strap in a deployed configuration shown in accordance with another embodiment; and

FIG. 8 is a perspective view of a wearable fall protection harness and a trauma relief strap in a deployed configuration.

### DETAILED DESCRIPTION OF THE PREFERRED EMBODIMENTS

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used in the specification and the claims, the singular form of “a”, “an”, and “the” include plural referents unless the context clearly dictates otherwise. As used in the specification and the claims, the term “end” refers to the extreme distal portion or the area near or adjacent that portion. Unless otherwise specified, the use of the term “attach”, “attachable”, and/or “attachment” includes a permanent, semi-permanent, removable, or adjustable attaching arrangement. As used in the specification and the claims, the term “integrated”, when used with reference to a trauma relief strap and a harness, means that a trauma relief strap is formed as a separate component or arrangement and can be combined in, on, or with at least a portion of a separately formed harness (e.g., at least one strap or portion of a strap of the harness), such that the two components together constitute a whole. Therefore, the terms “therewith”, “therein”, and “thereon” are used interchangeably in the context of the present description.

As used in the specification and the claims, the term “substantially parallel” means a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used in the specification and the claims, all ranges or ratios disclosed herein are to be understood to encompass any and all subranges or sub-ratios subsumed therein. For aspect or embodiment, a stated range or ratio of “1 to 10” should be considered to include any and all subranges between (and inclusive of) the minimum value of 1 and the maximum value of 10; that is, all sub-ranges or sub-ratios beginning with a minimum value of 1 or more and ending with a maximum value of 10 or less, such as but not limited to, 1 to 6.1, 3.5 to 7.8, and 5.5 to 10.

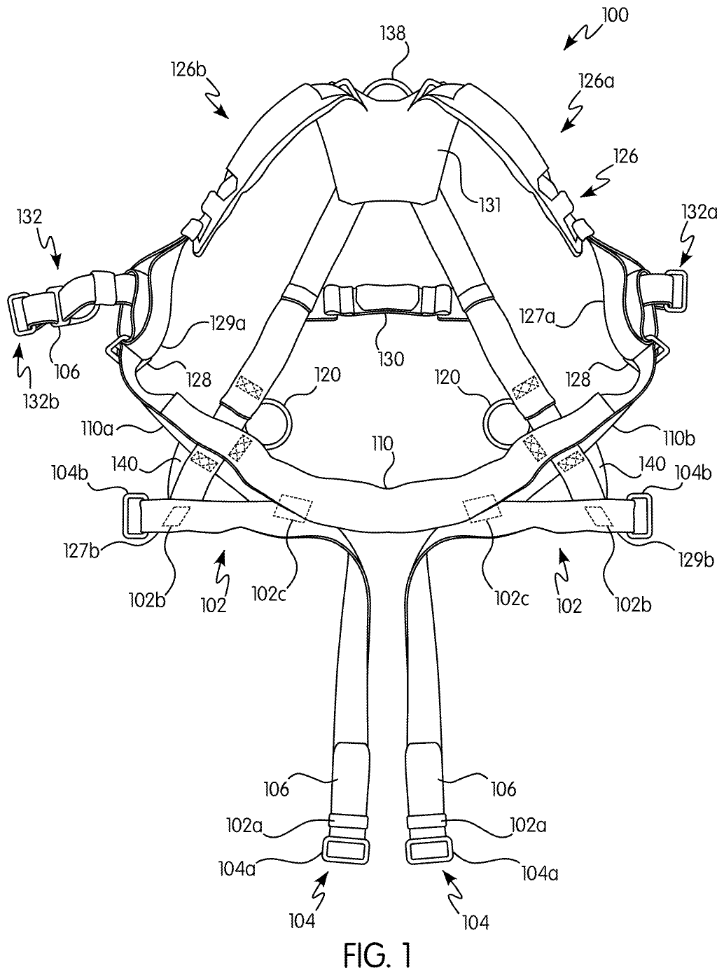

In various non-limiting embodiments or aspects, and with reference to FIG. 1, the present disclosure is directed to a safety harness 100 (hereinafter referred to as “harness 100”) used in a fall protection system. As discussed herein, the harness 100 has at least one trauma relief strap integrated therewith and configured for relieving pressure on the user's legs due to the leg straps when the user is suspended in the harness 100.

With continued reference to FIG. 1, the harness 100 has at least two leg straps 102 configured to attach around a user's legs below a user's groin area. When attached, the leg straps 102 loop around or encircle each of the user's legs. Each leg strap 102 has a first end 102a that is removably attachable to a second end 102b via a connector 104. In some non-limiting embodiments or aspects, the connector 104 may be a clip, a buckle, a mating arrangement, an actuatable structure, or the like. The connector 104 permits removable attachment of the first end 102a to the second end 102b of each leg strap 102. In this manner, the first and second ends 102a, 102b of the leg straps 102 are configured to be removably attached to each other and configured to be free floating when detached from each other. In some non-limiting embodiments or aspects, at least one connector 104 and/or the leg strap 102 may have at least one connection mechanism 106 configured for adjusting the length of each leg strap 102. In this manner, the at least one connection mechanism 106 adjusts a distance between the first end 102a and the second end 102b such that each leg strap 102 may be adjusted to fit comfortably around the user's legs. Each leg strap 102 may be formed from a substantially flat webbing material typically used in harness construction.

In various non-limiting embodiments or aspects, the leg straps 102 (or, indeed, any of the straps in the harness 100) may be linear lengths of material, folded straps that form loops with the at least one connector 104 at the first end 102a and/or the second end 102b, or the like. For example, as shown in FIG. 1, the connector 104 may have a first portion 104a that is non-adjustably attached to the first end 102a of at least one leg strap 102, while a second portion 104b of the connector 104 is adjustably secured at the second end 102b of at least one leg strap 102 through a loop of the material that makes up the leg strap 102. Therefore, in such an arrangement, the second portion 104b of the connector 104 and the loop of material that makes up the leg strap 102 at the second end 102b defines the at least one connection mechanism 106 for adjusting a length of the leg strap 102. It should be noted that the position of the connection mechanism 106 may be reversed such that the second portion 104b of the connector 104 is provided on the first end 102a of the leg strap 102. At least one leg strap 102 may include padding (not shown) for increasing the user's comfort while wearing the harness 100.

With continued reference to FIG. 1, each leg strap 102 is connected to a belt strap 110 at a substantially intermediate portion 102c of the leg strap 102 between the first end 102a and the second end 102b. For example, each leg strap 102 may be connected to the belt strap 110. In some non-limiting embodiments or aspects, the substantially intermediate portion 102c of the leg strap 102 may be directly and non-movably connected to the belt strap 110, such as being sewn directly to the belt strap 110. In other non-limiting embodiments or aspects, the substantially intermediate portion 102c of each leg strap 102 may be connected to the rear end of the belt strap 110 by a connection strap (not shown) to allow the substantially intermediate portion 102c of the leg strap 102 to slidably move along a front portion of the leg strap 102. Accordingly, the position of the leg straps 102 may be adjusted relative to the belt strap 110 to increase the user's comfort while wearing the harness 100.

With continued reference to FIG. 1, the belt strap 110 is configured to encircle at least a portion of the user's torso. The belt strap 110 has a first end 110a that is attached to a first portion of a shoulder strap 126 and a second end 110b that is attached to a second portion of the shoulder strap 126. The first end 110a and the second end 110b may be removably or non-removably attachable to the shoulder strap 126. In some embodiments or aspects, at least one of the first end 110a and the second end 110b may be attachable to the shoulder strap 126 via a connector similar to the connector 104 described herein with reference to the leg straps 102. In some non-limiting embodiments or aspects, the belt strap 110 may have at least one connection mechanism 106 configured for adjusting the length of the belt strap 110. In this manner, the at least one connection mechanism 106 adjusts a distance between the first end 110a and the second end 110b such that the belt strap 110 may be adjusted to fit comfortably around the user's torso. One or more handles, clips, and/or connectors 120 may be provided on at least a portion of the belt strap 110. The belt strap 110 may include padding (not shown) for increasing the user's comfort while wearing the harness 100. The belt strap 110 may be formed from a substantially flat webbing material typically used in harness construction.

With continued reference to FIG. 1, the harness 100 further has the shoulder strap 126 configured to extend over at least a portion of the user's shoulders. The shoulder strap 126 may have a first shoulder strap 126a and a second shoulder strap 126b arranged to overlap one another in an X-shaped configuration. In some non-limiting embodiments or aspects, the shoulder strap 126 may have at least one shoulder pad 131 having one or more openings through which the first shoulder strap 126a and the second shoulder strap 126b can be arranged to maintain the first shoulder strap 126a and the second shoulder strap 126b in the X-shaped configuration.

As further shown in FIG. 1, the first shoulder strap 126a has a first end 127a that is connected to the second end 110b of the belt strap 110. The first end 127a of the first shoulder strap 126a may be removably or non-removably attachable to the second end 110b of the belt strap 110. In some non-limiting embodiments or aspects, the first end 127a of the first shoulder strap 126a may be attached to the second end 110b of the belt strap 110 via a connector similar to the connector 104 described herein with reference to the leg straps 102. The first shoulder strap 126a further has a second end 127b that is connected to one of the two leg straps 102. In some non-limiting embodiments or aspects, the second end 127b of the first shoulder strap 126a is connected to the leg strap 102 proximate to the second end 102b of the leg strap 102, such as by being sewn directly to the leg strap 102. The first shoulder strap 126a may have at least one loop 128 through which the first end 110a of the belt strap 110 may be passed. At least a portion of the first shoulder strap 126a may be formed from a substantially flat webbing material typically used in harness construction.

With continued reference to FIG. 1, the second shoulder strap 126b has a first end 129a that is connected to the first end 110a of the belt strap 110. The first end 129a of the second shoulder strap 126b may be removably or non-removably attachable to first end 110a of the belt strap 110. In some embodiments or aspects, the first end 129a of the second shoulder strap 126b may be attached to the first end 110a of the belt strap 110 via a connector similar to the connector 104 described herein with reference to the leg straps 102. The second shoulder strap 126b further has a second end 129b that is connected to the other of the two leg straps 102. In some non-limiting embodiments or aspects, the second end 129b of the second shoulder strap 126b is connected to the leg strap 102 proximate to the second end 102b of the leg strap 102, such as by being sewn directly to the leg strap 102. The second shoulder strap 126b may have at least one loop 128 through which the second end 110b of the belt strap 110 may be passed. At least a portion of the second shoulder strap 126b may be formed from a substantially flat webbing material typically used in harness construction.

As further shown in FIG. 1, the harness 100 may have a back strap 130 connecting a substantially intermediate portion of the first shoulder strap 126a between its first end 127a and second end 127b with a substantially intermediate portion of the second shoulder strap 126b between its first end 129a and second end 129b. A position of the back strap 130 may be adjustable along a longitudinal direction of the first shoulder strap 126a and the second shoulder strap 126b, such as by sliding the back strap 130 along the first shoulder strap 126a and/or the second shoulder strap 126b.

With continued reference to FIG. 1, the harness 100 further may have a chest strap 132 having a first end 132a removably connectable to a second end 132b. The first end 132a of the chest strap 132 may be positioned proximate to the first end 127a of the first shoulder strap 126a, while the second end 132b of the chest strap 132 may be positioned proximate to the first end 129a of the second shoulder strap 126b. The first end 132a of the chest strap 132 is removably attachable to the second end 132b via a connector, similar to the connector 104 described herein with reference to the leg straps 102. In some non-limiting embodiments or aspects, the connector 104 may be a clip, a buckle, a mating arrangement, an actuatable structure, or the like. In this manner, the first and second ends 132a, 132b of the chest strap 132 are configured to be removably attached to each other and configured to be free floating when detached from each other. In some non-limiting embodiments or aspects, at least one of the back strap 130 and the chest strap 132 may have at least one connection mechanism, such as the connection mechanism 106 described herein with reference to the leg straps 102. The connection mechanism 106 is configured for adjusting the length of the back strap 130 and/or the chest strap 132. The back strap 130 and the chest strap 132 may be formed from a substantially flat webbing material typically used in harness construction.

As further shown in FIG. 1, the shoulder strap 126 has an anchor element, such as a D-ring 138, for connecting at least a portion of the shoulder strap 126 to a line connected to an anchor point. In some non-limiting embodiments or aspects, at least a portion of the first shoulder strap 126a and the second shoulder strap 126b is looped around or otherwise permanently attached to the D-ring 138. The D-ring 138 has a frame defining at least one opening through which the first shoulder strap 126a and the second shoulder strap 126b may be looped around and through which a clip, such as a carabiner, a lanyard, or other rope or line, can be secured to connect the harness 100 to an anchor point.

With continued reference to FIG. 1, the harness 100 has a trauma relief strap assembly 140 associated therewith. The trauma relief strap assembly 140 is operatively connected to at least a portion of the harness 100, such as at a hip portion of at least one leg strap 102. In some non-limiting embodiments or aspects, a separate trauma relief strap assembly 140 is operatively connected to the hip portion of each of the leg straps 102. In further non-limiting embodiments or aspects, the trauma relief strap assembly 140 is operatively connected to the belt strap 110, a handle 120, or any other portion of the harness 100. In each non-limiting embodiment or aspect, the trauma relief strap assembly 140 is configured for relieving pressure on the user's body due to the leg straps 102 when the user is suspended within the harness 100 after a fall event.

The trauma relief strap assembly 140 of the present invention may be integrated with the harness 100 when the harness 100 is manufactured. Alternatively, the trauma relief strap assembly 140 may be retrofitted to an existing harness 100 that does not have a trauma relief strap assembly 140. In some non-limiting embodiments or aspects, the trauma relief strap assembly 140 may be reusable on another harness 100 should the original harness 100 be discarded due to damage after the fall event.

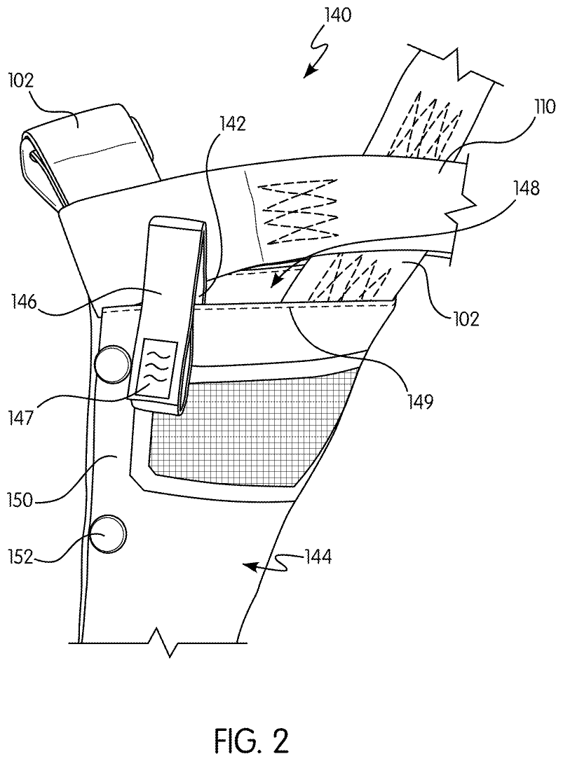

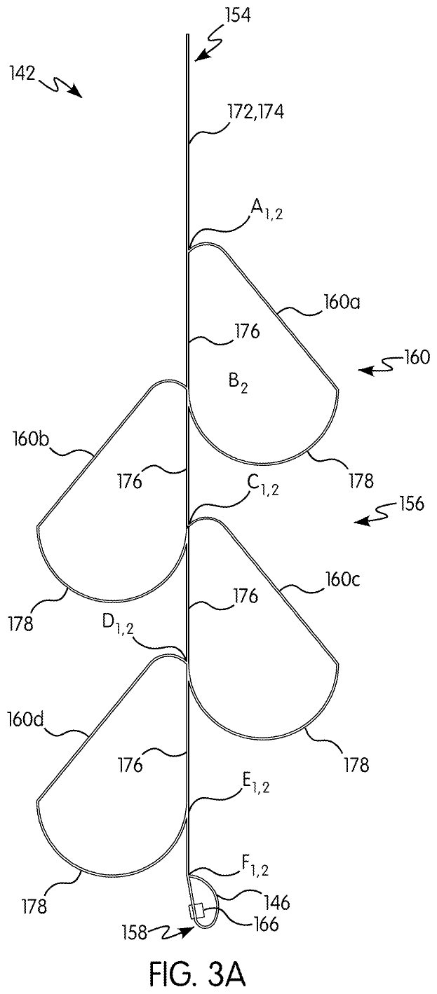

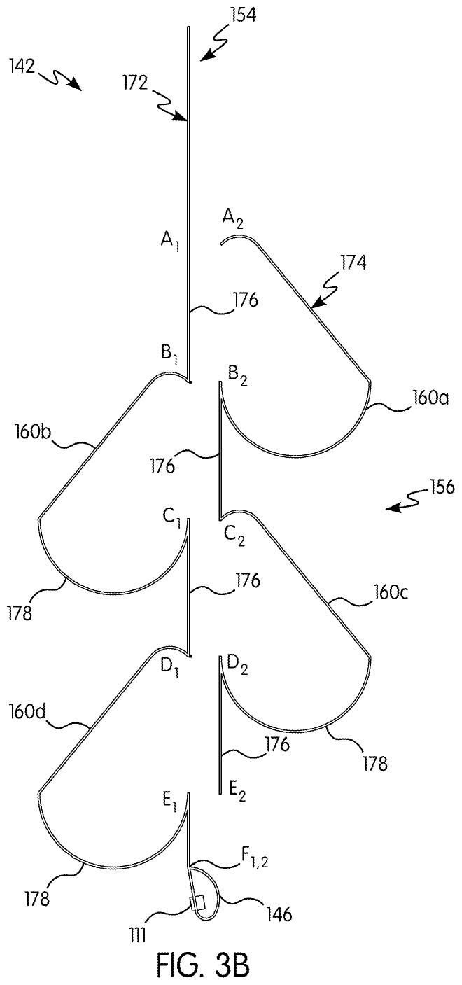

The trauma relief strap assembly 140 includes a relief strap 142 and a housing 144. The relief strap 142 is deployable from the housing 144 between a stowed configuration (shown in FIGS. 1-2) and a deployed configuration (shown in FIGS. 3A-3B). The housing 144 encloses the relief strap 142 until the relief strap 142 is ready for use, as described herein. Desirably, the trauma relief strap assembly 140 is positioned in an easy-to-reach location such that the user can easily deploy the relief strap 142 while suspended within the harness 100. The relief strap 142 may be folded, wound, or rolled into a cavity of the housing 144. In some non-limiting embodiments or aspects, the relief strap 142 may be fully contained within an interior cavity of the housing 144. In other non-limiting embodiments or aspects, the relief strap 142 may be at least a partially exposed from the interior cavity of the housing 144. Desirably, the exposed portion of the relief strap 142 is placed relative to the harness 100 such that the relief strap 142 is easily accessible to the user. For example, a pull strap 146 may be provided on at least a portion of the relief strap 142. The pull strap 146 may be at least partially exposed from the housing 144 for releasing the relief strap 142 from the stowed configuration within the interior cavity of the housing 144. Desirably, the pull strap 146 is sized appropriately such that it can be easily grabbed by the user, even if the user is wearing gloves. In some non-limiting embodiments or aspects, the pull strap 146 may have indicia 147 provided thereon to highlight the position of the pull strap 146 and/or to provide instructions to the user regarding how the relief strap 142 is to be deployed from the stowed position. For example, the pull strap 146 may be conspicuously colored, such as in a bright green, red, orange, or yellow color. Alternatively, or in addition, the pull strap 146 may contain printed instructions for releasing the relief strap 142 from the stowed configuration, such as “Pull to Release”.

With reference to FIG. 2, the housing 144 may be formed as a pocket 149 having an interior cavity shaped and sized to receive at least a portion of the relief strap 142. The housing 144 desirably does not protrude substantially from the harness 100 to eliminate formation of a catch point at which the user can snag the harness 100. The housing 144 may be connected to at least a portion of the harness 100, such as being connected to at least a portion of the leg strap 102, for example at a hip portion of the leg strap 102. The housing 144 may be integrally formed with the harness 100, such as at least a portion of at least one of the straps of the harness 100. In some non-limiting embodiments or aspects, a separate housing 144 may be directly integrated with at least a portion of each leg strap 102 such that the housing 144 forms a pad or a pouch for containing the trauma relief strap assembly 140. In some non-limiting embodiments or aspects, the housing 144 has at least one opening 148 through which the relief strap 142 can be removed from the pocket 149. The housing 144 may have a flap 150 that is movable between a closed position to enclose the pocket 149, and an open position to open the pocket 149 and facilitate removal of the relief strap 142 from the housing 144. The flap 150 may be removably connectable to at least a portion of the harness 100, such as at least a portion of the leg strap 102. In some non-limiting embodiments or aspects, the flap 150 may be connected to the hip portion of the leg strap 102 by one or more connectors, such as one or more snap buttons 152. In other non-limiting embodiments or aspects, the flap 150 may be connected to the hip portion of the leg strap 102 by a zipper, hook-and-loop fastener, a clip, an adhesive, a tearable connection, or any combination thereof. Any other suitable connector may be used to secure the flap 150 to the hip portion of the leg strap 102. The housing 144 is preferably made from a lightweight material, such as nylon.

With reference to FIGS. 3A-3B, the relief strap 142 is shown in a deployed configuration. The housing 144 is omitted for clarity. The relief strap 142 has a first end 154, an intermediate portion 156, and a second end 158. The relief strap 142 may be made from a substantially flat webbing material typically used in harness construction. In some non-limiting embodiments or aspects, the relief strap 142 may be made from a material configured for maintaining a load of no less than a weight of the user and up to 1,000 pounds.

The first end 154 is configured for attachment with at least a portion of the harness 100, such as the hip portion of the leg strap 102 (shown in FIG. 1). Attaching the first end 154 of the relief strap 142 to the hip portion of the leg strap 102 allows the user to “stand” on the relief strap 142 and eliminates pressure points on the user's body by the harness 100 when the user is suspended within the harness 100 after the fall event. This allows blood to flow back into the user's legs while the user remains suspended in the harness 100. In some non-limiting embodiments or aspects, the first end 154 is attached to at least a portion of the leg strap 102 by stitching. In other non-limiting embodiments or aspects, the first end 154 may be looped over at least a portion of the leg strap 102 and then stitched to the hip portion of the leg strap 102 and/or to the intermediate portion 156 of the relief strap 142. Although stitching is one method for attaching the first end 154 of the relief strap 142 to the leg strap 102, other methods are not precluded. For example, the first end 154 may be attached to the hip portion of the leg strap 102 or any other portion of the harness 100 via adhesive, clips, loops, or other known connection mechanisms.

With continued reference to FIGS. 3A-3B, the intermediate portion 156 has a plurality of steps 160 extending from lateral surfaces of the intermediate portion 156. In some non-limiting embodiments or aspects, the intermediate portion 156 has a pair of steps 160 on each lateral side. Each step 160 is shaped and sized for receiving the user's foot when the relief strap 142 is in the deployed position. For example, each step 160 is configured as a closed loop that protrudes laterally from a side of the intermediate portion 156. In some non-limiting embodiments or aspects, the steps 160 may be arranged at offset positions along a longitudinal length of the intermediate portion 156. For example, a first step 160a may be closer to the first end 154 than a second step 160b, which is closer to the first end 154 than a third step 160c, which is closer to the first end 154 than a fourth step 160d. It is envisioned that any number of steps 160 may be used in accordance with the spirit and scope of the invention.

With reference to FIG. 3B, at least a portion of the relief strap 142, such as the intermediate portion 156, may be formed from at least a first strap 172 and a second strap 174 connected to each other at two or more predetermined connection points along a major longitudinal length thereof. The one or more steps 160 are formed as closed loops between two adjacent connection points between the first strap 172 and the second strap 174. In a relief strap 142 having four steps 160a-160d, the first strap 172 may be attached to the second strap 174 at five predetermined connection points A-E (shown in FIGS. 5-6).

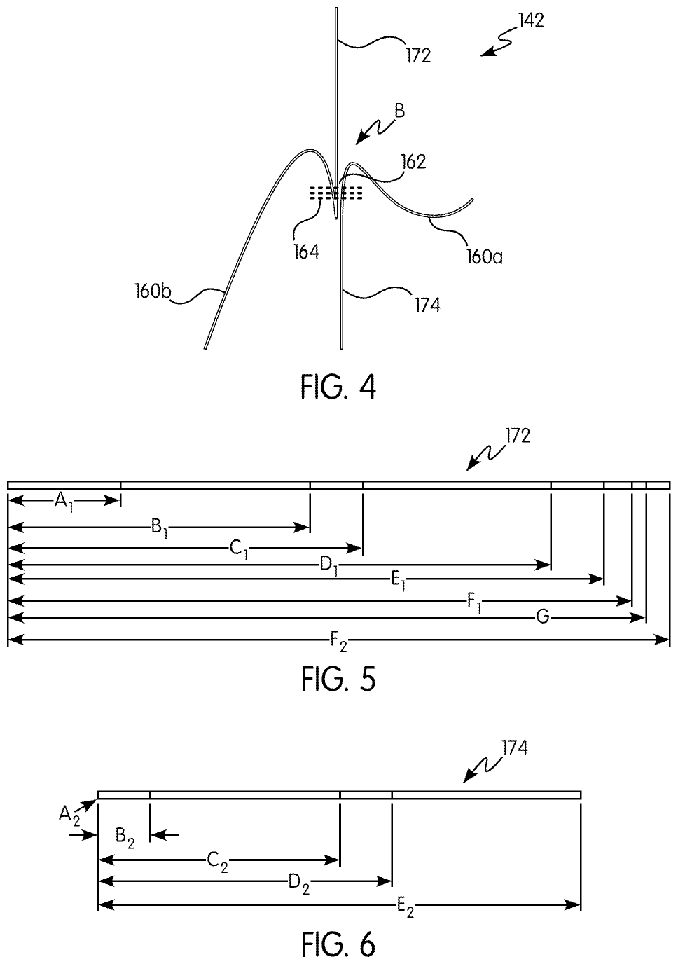

With reference to FIGS. 3A-3B, each step 160a-160d has a longitudinal portion 176 extending in a direction of the major longitudinal length of the relief strap 142 and defined by one of the first strap 172 and the second strap 174, and a lateral portion 178 protruding laterally from the longitudinal portion 176 and defined by the other of the first strap 172 and the second strap 174. FIG. 4 illustrates connection point B, which is formed by folding an upper of the two straps 172, 174 (in this case, the second strap 174) over itself in a direction away from the lower of the two straps 172, 174 (in this case, the first strap 172), and folding the lower of the two straps 172, 174 (the first strap 172) over itself in a direction away from the upper of the two straps 172, 174 (the second strap 174). In this manner, a folding region 162 is formed at which the two straps 172, 174 can be joined together, such as with stitching 164. In other non-limiting embodiments or aspects, the two straps 172, 174 can be joined together by an adhesive, snaps, hooks, or other connection mechanisms. The two straps 172, 174 are joined at the folding region 162 such that the webbing of the straps 172, 174 is directed in an upward direction. By folding each of the straps 172, 174 in this manner, the steps 160 have a natural tendency to automatically fold open (rather than remain flat) when the relief strap 142 is opened to the deployed configuration, thereby making it easier for the user to place his/her foot into one of the steps 160.

With reference to FIGS. 5-6, the first strap 172 has five predetermined connection points A₁, B₁, C₁, D₁, and E₁ that correspond to the five predetermined connection points A₂, B₂, C₂, D₂, and E₂ on the second strap 174. The first and second straps 172, 174 are joined at each of the predetermined connection points by folding the straps 172, 174 as described herein to define a folding region 162 (shown in FIG. 4) and then attaching the straps 172, 174 to each other, such as with stitching 164 (shown in FIG. 4). With relief straps 142 having more or fewer steps 160 than shown in FIGS. 3A-3B, the number of predetermined connection points is based on the number of steps 160.

With reference to FIGS. 3A-3B, the second end 158 of the relief strap 142 has the pull strap 146 formed by looping the first strap 172 and attaching ends F1, F2 together, such as by stitching. A button 166 may be provided at the second end 158 for securing the second end 158 to the harness 100 and/or the housing 144 when the relief strap 142 is in a stowed position.

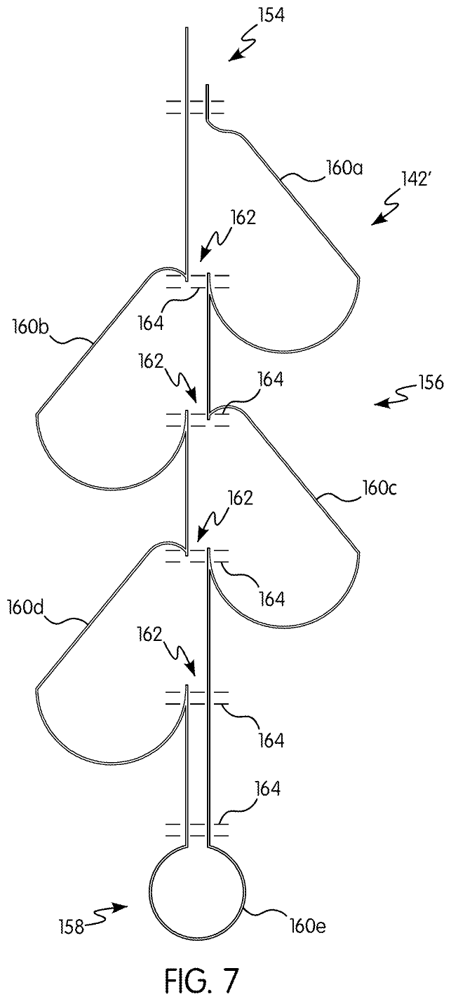

With reference to FIG. 7, a relief strap 142′ is shown in accordance with another embodiment of the present disclosure. The components of the relief strap 142′ shown in FIG. 7 are substantially similar or identical to the components of the relief strap 142 described herein with reference to FIGS. 3A-3B. Reference numerals in FIG. 7 are used to illustrate identical components of the corresponding reference numerals in FIGS. 3A-3B. As the previous discussion regarding the relief strap 142 generally shown in FIGS. 3A-3B is applicable to the embodiment of the relief strap 142′ shown in FIG.7, only the relative differences between the two relief straps are discussed hereinafter.

Rather than being formed from two separate straps, such as the first strap 172 and the second strap 174 shown in FIGS. 3A-3B, the relief strap 142′ of FIG. 7 is formed from a single piece of material that is looped at predetermined portions to define the one or more steps 160a-160d. Each step 160a-160d is formed as a closed loop defined by a pair of folding regions 162 where the one portion of the relief strap 142′ is sewn to another portion of the relief strap 142′. The two portions of the relief strap 142′ are joined at each folding region 162 by stitching 164. In other non-limiting embodiments or aspects, the two portions of the relief strap 142′ are joined at each folding region 162 can be joined together by an adhesive, snaps, hooks, or other connection mechanisms.

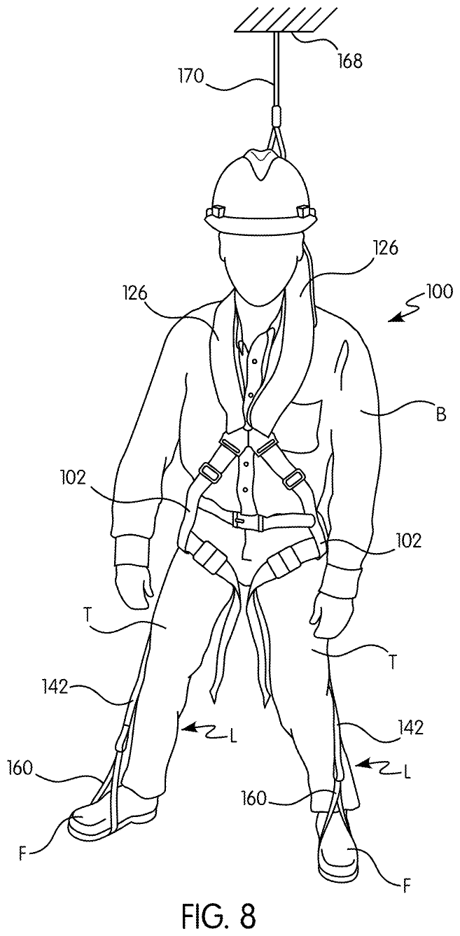

Having described the structure of the harness 100 and the trauma relief strap assembly 140, a method of deploying the relief straps 142 will now be described with reference to FIG. 8. In the event of a fall, the user is suspended in a substantially vertical position from an anchor structure 168 by a lanyard 170 connected to the D-ring 138 (not shown). The user's body B is pulled downward due to gravity, which tends to urge the harness 100 in an upward direction relative to the user's body B, thereby creating pressure points on the user's body B. Pressure is likely to be applied in the area of the user's thighs T due to the routing of the leg straps 102.

To reduce the risk of suspension trauma due to such pressure applied by the harness 100, the user deploys the relief straps 142 positioned on both sides of the harness 100 by pulling on the pull strap 146 of each relief strap 142 to release the relief strap 142 from the housing 144 and/or the harness 100. In some non-limiting embodiments or aspects, pulling on the pull strap 146 may also open the flap 150 to allow for easier deployment of the relief straps 142. In other non-limiting embodiments or aspects, the user may open the flap 150 before pulling the pull strap 146. When the pull strap 146 is pulled, the relief strap 142 can be deployed from the housing 144 such that the relief strap 142 is positioned on the sides of user's legs L. As discussed herein, due to the attachment between the first and second straps 172, 174 of the relief strap 142, the steps 160 on the intermediate portion 156 of the relief strap 142 have a natural tendency to fold open (rather than remain flat), thereby making it easier for the user to place his/her foot F into one of the steps 160. By positioning both feet F into the steps 160, the user can effectively “stand” in the harness 100, thereby reducing the pressure of the leg straps 102 on the user's thighs T. In this manner, the load due to the user's weight is applied between the D-ring 138 and the relief straps 142, allowing the other straps of the harness 100 to loosen and relieve pressure on the user's body. The user can position his/her feet F within one of the plurality of steps 160a-160d (shown in FIG. 3) to find a comfortable “standing” position based on the length of the user's legs L.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A trauma relief strap assembly, comprising:
a relief strap having a first strap and a second strap connected to the first strap at two or more connection points along a major longitudinal length of the relief strap, and
one or more steps formed as a closed loop between two adjacent connection points,
wherein each step has a longitudinal portion extending in a direction of the major longitudinal length of the relief strap and defined by one of the first strap and the second strap, and a lateral portion protruding laterally from the longitudinal portion and defined by the other of the first strap and the second strap.

2. The trauma relief strap assembly of claim 1, wherein, for at least one connection point, the first strap is folded over itself in a first lateral direction away from the second strap and the second strap is folded over itself in a second lateral direction away from the first strap.

3. The trauma relief strap assembly of claim 1, wherein the lateral portion of each step automatically unfolds from the longitudinal portion when the relief strap is in a deployed configuration to allow for insertion of a user's foot into each step.

4. The trauma relief strap assembly of claim 1, wherein the first strap and the second strap are connected together at each connection point by stitching.

5. The trauma relief strap assembly of claim 1, wherein the relief strap has a first end, an intermediate portion, and a second end, and wherein the first strap and the second strap are connected together along at least the intermediate portion.

6. The trauma relief strap assembly of claim 1, wherein the one or more steps is a plurality of steps extending from each lateral side of the relief strap.

7. The trauma relief strap assembly of claim 6, wherein the plurality of steps are offset along the major longitudinal length of the relief strap.

8. The trauma relief strap assembly of claim 1, wherein one of the first strap and the second strap is configured for non-removably connecting to a wearable body harness.

9. The trauma relief strap assembly of claim 1, wherein one of the first strap and the second strap has a pull strap configured for deploying the relief strap from the stowed configuration to a deployed configuration.

10. The trauma relief strap assembly of claim 9, wherein the pull strap is at least partially exposed from a housing when the relief strap is in a stowed configuration.

11. The trauma relief strap assembly of claim 9, further comprising indicia on at least a portion of the pull strap.

12. The trauma relief strap assembly of claim 1, further comprising a housing for receiving at least a portion of the relief strap in a stowed configuration.

13. The trauma relief strap assembly of claim 12, wherein the housing has a pocket with an interior cavity shaped to receive at least a portion of the relief strap.

14. The trauma relief strap assembly of claim 12, wherein the housing is configured as a pad.

15. The trauma relief strap assembly of claim 14, wherein the housing has a flap movable between a closed position to enclose the pocket and an open position to open the pocket.

16. A safety harness, comprising:
a first leg strap and a second leg strap; and
a trauma relief strap assembly connected to each of the first leg strap and the second leg strap, the trauma relief strap assembly comprising:
a relief strap having a first strap connected to the first leg strap or the second leg strap and a second strap connected to the first strap at two or more connection points along a major longitudinal length of the relief strap, and
one or more steps formed as a closed loop between two adjacent connection points,
wherein each step has a longitudinal portion extending in a direction of the major longitudinal length of the relief strap and defined by one of the first strap and the second strap, and a lateral portion protruding laterally from the longitudinal portion and defined by the other of the first strap and the second strap.

17. The safety harness of claim 16, wherein, for at least one connection point, the first strap is folded over itself in a first lateral direction away from the second strap and the second strap is folded over itself in a second lateral direction away from the first strap.

18. The safety harness of claim 16, wherein the trauma relief strap assembly is deployable between a stowed configuration in which the relief strap is stored within a housing, and a deployed configuration in which the relief strap extends out of the housing and substantially parallel to a user.

19. The safety harness of claim 18, wherein the lateral portion of each step automatically unfolds from the longitudinal portion when the relief strap is in the deployed configuration to allow for insertion of a user's foot into each step.

20. A trauma relief strap assembly, comprising:
a relief strap having a first end configured for connecting to at least a portion of a wearable body harness, an intermediate portion, and a second end, the intermediate portion comprising a first strap and a second strap connected to the first strap at two or more connection points along a major longitudinal length of the intermediate portion, and
one or more steps formed as a closed loop between two adjacent connection points,
wherein each step has a longitudinal portion extending in a direction of the major longitudinal length of the relief strap and defined by one of the first strap and the second strap, and a lateral portion protruding laterally from the longitudinal portion and defined by the other of the first strap and the second strap, and
wherein, at each connection point, the first strap is folded over itself in a first lateral direction away from the second strap and the second strap is folded over itself in a second lateral direction away from the first strap.
